(19) United States
(12) Patent Application Publication
(10) Pub. No.: US 2023/0182471 A1
(43) Pub. Date: Jun. 15, 2023

(54) INKJET RECORDING APPARATUS

(71) Applicant: KYOCERA Document Solutions Inc., Osaka-shi (JP)

(72) Inventors: Masaaki NISHIHARA, Osaka-shi (JP); Takenori YAMAMOTO, Osaka-shi (JP); Masayuki MIYAKE, Osaka-shi (JP); Tatsuya CHUTO, Osaka-shi (JP); Toshihiko TANAKA, Osaka-shi (JP); Ryo SHIOMI, Osaka-shi (JP)

(21) Appl. No.: 17/928,673

(22) PCT Filed: May 19, 2021
(86) PCT No.: PCT/JP2021/018949

§ 371 Date: Nov. 30, 2022

(30) Foreign Application Priority Data
Jun. 3, 2020 (JP) 2020-097003

(51) Int. Cl. B41J 2/165; B41J 11/42

(52) U.S. Cl. CPC B41J 2/1652; B41J 11/42

(57) ABSTRACT

A data-generating unit of an inkjet recording apparatus recognizes, based on a detection signal of a recording medium output from a recording medium detection sensor, an open part region that is a region of an open part located in a position shifted from a recording medium detected by the recording medium detection sensor in a transport direction among regions of a plurality of open parts included in an open part reading data read by an open part detection sensor to generate flushing data in accordance with the open part region. A flushing control unit recognizes at least one non-image-forming period in which the open part corresponding to the region passes a position facing the recording head by running of the transport belt, based on the detection signal, and causes the recording head to execute flushing, based on flushing data, in the at least one non-image-forming period.

### TECHNICAL FIELD

The present disclosure relates to an inkjet recording apparatus.

### BACKGROUND ART

Conventionally, inkjet recording apparatuses, such as inkjet printers or the like, flushing (idle ejection) in which ink is ejected from nozzles on a regular basis is performed in order to reduce or prevent nozzle clogging due to ink drying. For example, in an inkjet recording apparatus of Patent Literature 1, an open part is provided in a transport belt that transports a recording medium, and ink is ejected from each nozzle of a recording head to pass through the open part in the transport belt.

### CITATION LIST

### Patent Literature

PTL 1:Japanese Unexamined Patent Application Publication No. 2011-213095

### SUMMARY OF THE INVENTION

### Problems to be Solved by the Invention

Incidentally, flushing of the recording head is usually performed by driving the recording head, based on flushing data prepared in advance. However, for example, if the transport belt meanders or if a position, a size, and a shape of the open part differ for each transport belt used, when the recording head is driven based on the flushing data, ink ejected from each nozzle of the recording head does not pass through the open part and sticks around the open part to stain the transport belt in some cases. Therefore, in order to cause ink ejected from each nozzle to pass through the open part even when meandering of the transport belt or the like occurs, a method for accurately performing flushing is needed. However, the method is no examined at all in the Patent Literature 1.

In view of the above-described problems, it is an object of the present disclosure to provide an inkjet recording apparatus that can accurately perform flushing even when a transport belt meanders or a position, a size, and a shape of an open part differs for each transport belt used.

### Means for Solving the Problem

An inkjet recording apparatus according to one aspect of the present disclosure includes a recording head having a plurality of nozzles that eject ink, a transport belt having a plurality of open parts and sequentially transporting a recording medium in a transport direction, a flushing control unit that causes the recording head to execute flushing in which the ink is ejected from each of the nozzles of the recording head at a timing different from a timing that contributes to image forming to cause the ink to pass through one of the plurality of open parts, a recording medium detection sensor that detects the reading medium to output a detection signal, an open part detection sensor that reads the open parts of the transport belt to acquire open part reading data, and a data-generating unit that recognizes, based on the detection signal, an open part region that is a region of an open part located in a position shifted from the recording medium detected by the recording medium detection sensor in the transport direction among regions of the plurality of open parts included in the open part reading data to generate flushing data in accordance with the open part region. The flushing control unit recognizes at least one non-image-forming period in which the open part corresponding to the open part region passes a position facing the recording head by running of the transport belt, and causes the recording head to execute the flushing, based on the flushing data, in the at least one non-image-forming period.

### Effect of the Invention

According to the above-described configuration, flushing data is generated on an immediate spot (just before flushing) using the open part reading data acquired by directly reading each open part of the transport belt. Thus, ink ejected from each nozzle can accurately pass through each open part of the transport belt by driving each nozzle of the recording head, based on the generated flushing data, even when the transport belt meanders or the position, size, and shape of the open parts differ for each transport belt used. As a result, flushing can be performed accurately without being affected by meandering of the transport belt or the like.

### BRIEF DESCRIPTION OF THE DRAWINGS

FIG. 1 is an explanatory diagram illustrating a schematic configuration of a printer as an inkjet recording apparatus according to one embodiment of the present disclosure.

FIG. 2 is a plan view of a recording unit of the printer.

FIG. 3 is an explanatory diagram schematically illustrating a configuration around a paper transport path from a paper-feeding cassette to a second transport unit via a first transport unit in the printer.

FIG. 4 is a block diagram illustrating a hardware configuration of a major part of the printer.

FIG. 5 is a plan view illustrating a configuration example of a first transport belt of the first transport unit.

FIG. 6 is an explanatory diagram schematically illustrating a method for generating flushing data used for inter-paper flushing.

FIG. 7 is an explanatory diagram schematically illustrating another method for generating the flushing data.

FIG. 8 is an explanatory diagram schematically illustrating still another method for generating the flushing data.

FIG. 9 is an explanatory diagram schematically illustrating an arrangement pattern of open parts in the first transport belt.

FIG. 10 is an explanatory diagram schematically illustrating yet another method for generating the flushing data.

### MODE FOR CARRYING OUT THE INVENTION

### 1. Configuration of Inkjet Recording Apparatus

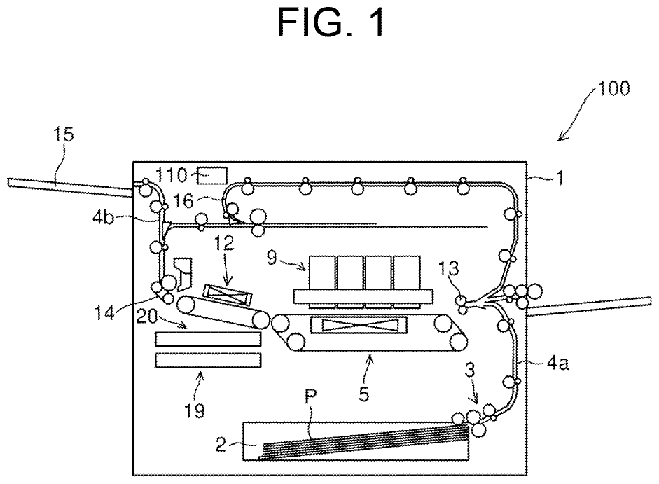

An embodiment of the present disclosure will be described below with reference to the accompanying drawings. FIG. 1 is an explanatory diagram illustrating a schematic configuration of a printer 100 as an inkjet recording apparatus according to one embodiment of the present disclosure. The printer 100 includes a paper-feeding cassette 2 as a paper storage unit. The paper-feeding cassette 2 is arranged in a lower portion of inside of a printer body 1. Papers P as an example of a recording medium are stored in the paper-feeding cassette 2.

A paper feeding apparatus 3 is arranged on a downstream side of the paper-feeding cassette 2 in a paper transport direction, that is, an upper right side of the paper-feeding cassette 2 in FIG. 1. The papers P are separated one by one to be fed out upward to right of the paper-feeding cassette 2 in FIG. 1 by the paper feeding apparatus 3.

The printer 100 includes a first paper transport path 4a therein. The first paper transport path 4a is located on the upper right side of the paper-feeding cassette 2 in a paper feeding direction thereof. The paper P fed out from the paper-feeding cassette 2 is transported perpendicularly upward via the first paper transport path 4a along a side surface of the printer body 1.

A pair of resist rollers 13 is provided at a downstream end of the first paper transport path 4a in the paper transport direction. Furthermore, a first transport unit 5 and a recording unit 9 are arranged in immediate vicinity of the pair of resist rollers 13 on a downstream side thereof in the paper transport direction. The paper P fed out from the paper-feeding cassette 2 reaches the pair of resist rollers 13 through the first paper transport path 4a. The pair of resist rollers 13 measures a timing with an ink ejection operation performed by the recording unit 9 while correcting oblique feed of the paper P, and feeds the paper P toward the first transport unit 5 (specifically, a first transport belt 8 that will be described later).

The paper P fed to the first transport unit 5 by the pair of resist rollers 13 is transported to a position facing the recording unit 9 (specifically, recording heads 17a to 17c that will be described later) by the first transport belt 8. Ink is ejected onto the paper P from the recording unit 9, and thus, an image is recorded on the paper P. At this time, ejection of the ink in the recording unit 9 is controlled by the control apparatus 110 inside the printer 100.

In the paper transport direction, a second transport unit 12 is arranged on a downstream side of the first transport unit 5 (on a left side in FIG. 1). The paper P on which the image has been recorded by the recording unit 9 is transported to the second transport unit 12. The ink ejected onto a surface of the paper P is dried while passing through the second transport unit 12.

In the paper transport direction, a decurler unit 14 is provided at a position on a downstream side of the second transport unit 12 and near a left side surface of the printer body 1. The paper P on which the ink has been dried by the second transport unit 12 is transported to the decurler unit 14 and curl of the paper P generated on the paper P is corrected.

In the paper transport direction, a second paper transport path 4b is provided on a downstream side of the decurler unit 14 (on an upper side in FIG. 1). In a case where both-side recording is not conducted, the paper P that has passed through the decurler unit 14 passes through the second paper transport path 4b and is discharged to a paper discharge tray 15 that is provided outside on a left surface of the printer 100.

A reverse transport path 16 used for performing both-side recording is provided at a position in an upper portion of the printer body 1 and above the recording unit 9 and the second transport unit 12. In a case where the both-side recording is conducted, the paper P on which recording on one surface (a first surface) is completed and which has passed through the second transport unit 12 and the decurler unit 14 is transported to the reverse transport path 16 through the second paper transport path 4b.

A transport direction of the paper P that has been transported to the reverse transport path 16 is switched for subsequent recording on the other surface (a second surface) of the paper P. Then, the paper P passes the upper portion of the printer body 1, is transported rightward, and is transported again to the first transport unit 5 via the pair of resist rollers 13 in a state where the second surface faces upward. In the first transport unit 5, the paper P is transported to the position facing the recording unit 9 and an image is recorded on the second surface by ink ejection from the recording unit 9. The paper P on which the both-side recording has been performed is discharged to the paper discharge tray 15 via the second transport unit 12, the decurler unit 14, and the second paper transport path 4b in this order.

A maintenance unit 19 and a cap unit 20 are arranged under the second transport unit 12. The maintenance unit 19 moves horizontally below the recording unit 9 when purging is executed, wipes the ink pushed out from an ink ejection port of the recording head, and collects the wiped ink. Purging refers to an operation of forcibly pushing out ink from an ink ejection port of a recording head in order to discharge thickened ink, a foreign substance, or air bubbles in the ink ejection port. The cap unit 20 moves horizontally below the recording unit 9 when capping of an ink ejection surface of the recording head is performed, further moves upward, and is mounted on a lower surface of the recording head.

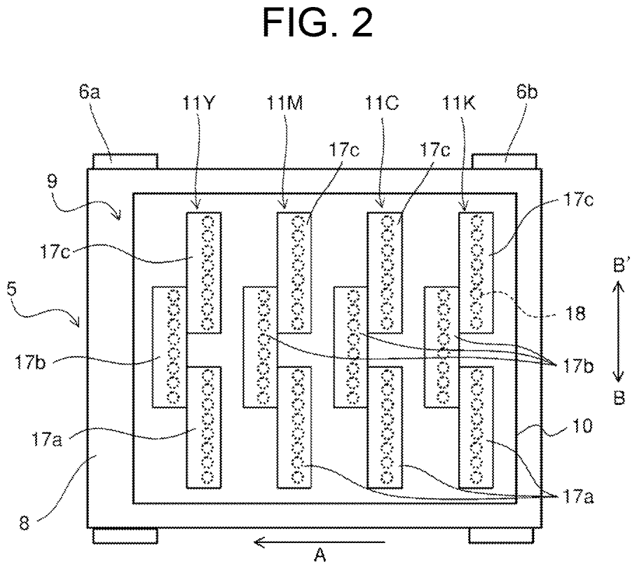

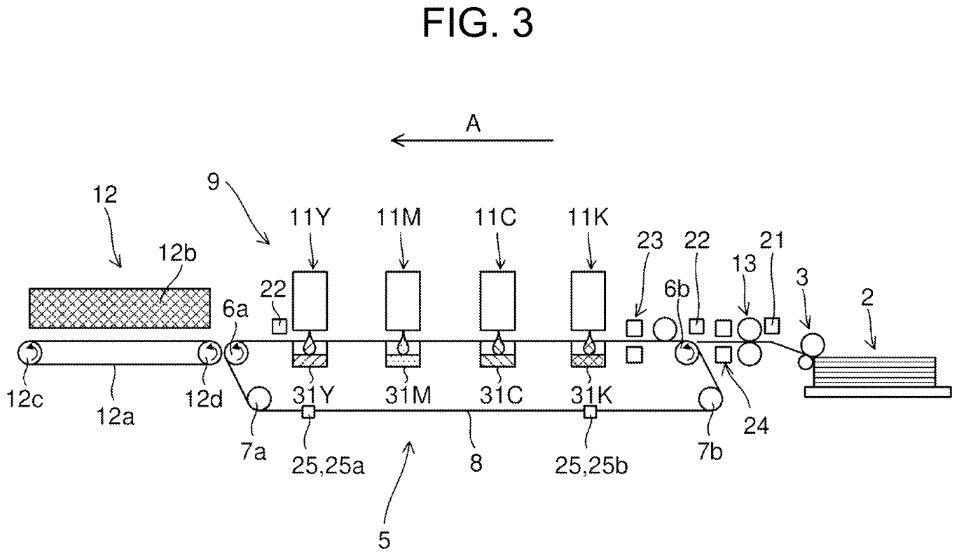

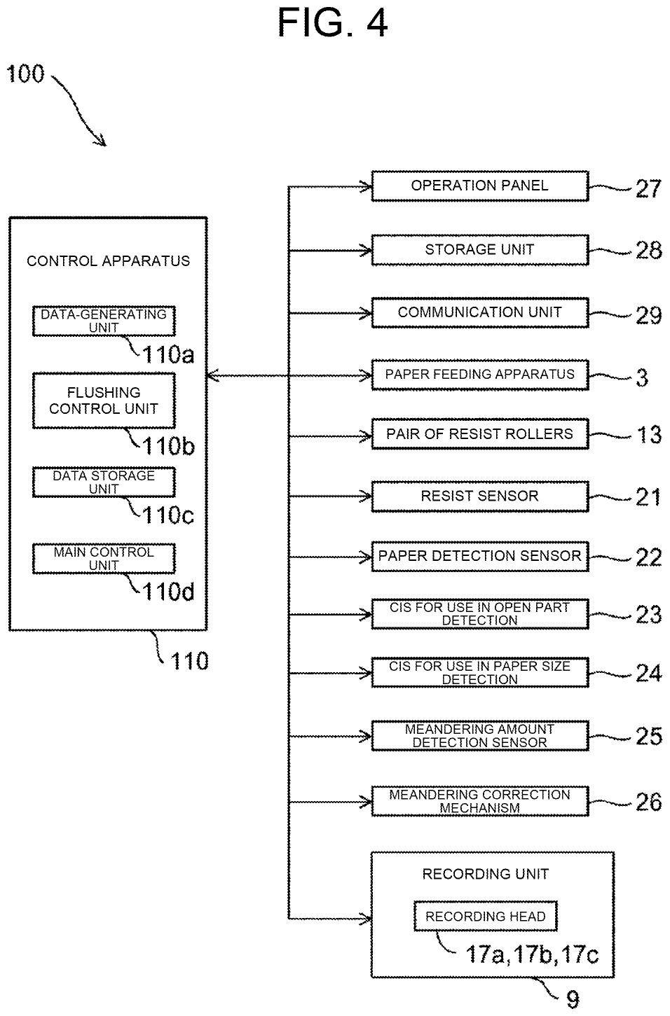

FIG. 2 is a plan view of the recording unit 9. The recording unit 9 includes a head housing 10 and line heads 11Y, 11M, 11C, and 11K. The line heads 11Y to 11K are held by the head housing 10 at a height where a specific space is formed (for example, 1 mm) with respect to a transport surface of the endless first transport belt 8 stretched around a plurality of rollers including a driving roller 6a, a driven rollers 6b, and tension rollers 7a and 7b (see FIG. 3). The driving roller 6a causes the first transport belt 8 to run in the transport direction of the paper P (an arrow A direction). Driving by the driving roller 6a is controlled by the main control unit 110d of the control apparatus 110 (see FIG. 4). The plurality of rollers described above are arranged along a running direction of the first transport belt 8 in an order of the tension roller 7a, the tension roller 7b, the driven roller 6b, and the driving roller 6a (see FIG. 3).

Each of the line heads 11Y to 11K includes a plurality of (three herein) recording heads 17a to 17c. The recording heads 17a to 17c are arranged in a staggered manner along a paper width direction (an arrow BB′ direction) that is orthogonal to the paper transport direction (the arrow A direction). Each of the recording heads 17a to 17c has a plurality of ink ejection ports 18 (nozzles). The ink ejection ports 18 are arranged to be aligned at regular intervals in a width direction of the recording head, that is, the paper width direction (the arrow BB′ direction). Ink in each color of yellow (Y), magenta (M), cyan (C), and black (K) is ejected onto the paper P that is transported on the first transport belt 8 from a corresponding one of the line heads 11Y to 11K via the ink ejection ports 18 of the recording heads 17a to 17c.

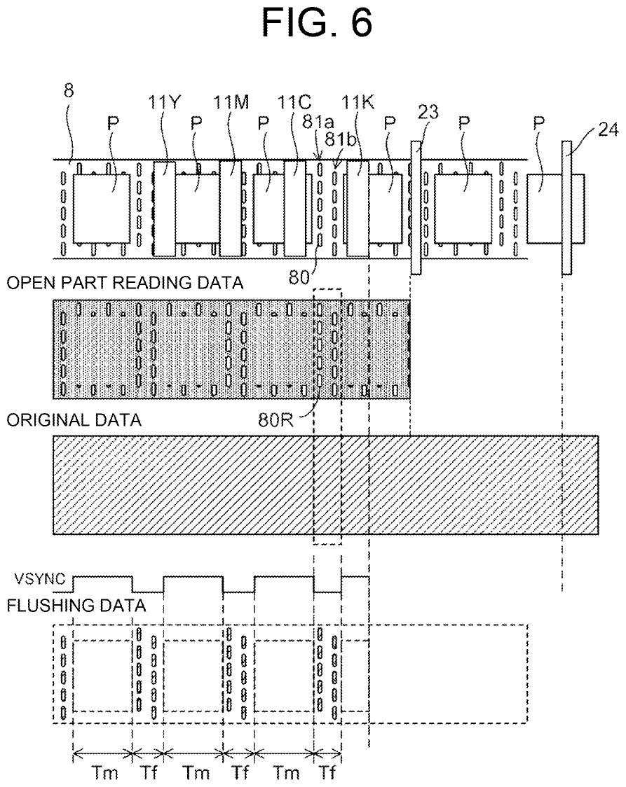

FIG. 3 schematically illustrates a configuration around the transport path of the paper P from the paper-feeding cassette 2 to the second transport unit 12 via the first transport unit 5. FIG. 4 is a block diagram illustrating a hardware configuration of a major part of the printer 100. In addition to the configuration described above, the printer 100 further includes a resist sensor 21, a paper detection sensor 22, a CIS 23 for use in open part detection, a CIS 24 for use in paper size detection, a meandering amount detection sensor 25, and a meandering correction mechanism 26. CIS is an abbreviation for contact image sensor and, although CISs of a transmissive type are employed in this embodiment, CISs of a reflective type may be employed. The CIS 23 for use in open part detection and the CIS 24 for use in paper size detection are formed in a long shape along the paper width direction (see FIG. 6).

The resist sensor 21 detects the paper P that is transported from the paper-feeding cassette 2 by the paper feeding apparatus 3 and is fed to the pair of resist rollers 13. The resist sensor 21 is located on an upstream side of the pair of resist rollers 13 in a feeding direction of the paper P. The main control unit 110d of the control apparatus 110, which will be described later, can control a rotation start timing of the pair of resist rollers 13, based on detection results at the resist sensor 21. For example, the main control unit 110d can control a timing of feeding the paper P to the first transport belt 8 after skew (oblique motion) correction is performed by the pair of resist rollers 13, based on the detection result at the resist sensor 21.

A paper detection sensor 22 is a recording medium detection sensor that detects the paper P and outputs a detection signal. In this embodiment, the paper detection sensor 22 is arranged between the line head 11K on a most upstream side of the first transport belt 8 in the paper transport direction and the pair of resist rollers 13 and detects passage (timing) of a front end and a rear end edge of the paper P fed from the pair of resist rollers 13 to the first transport belt 8.

The paper detection sensor 22 is located on an upstream side of the CIS 23 for use in open part detection in the paper transport direction but may be located on a downstream side of the CIS 23 for use in open part detection. The paper detection sensor 22 is formed of an optical sensor of a transmissive or reflective type, but may be formed of a CIS. The control apparatus 110 (for example, the main control unit 110d that will be described later) can control a timing of ejection of ink to the paper P that reaches each of positions facing the line heads 11Y to 11K (recording head 17a to 17c) by the first transport belt 8, based on detection results of paper P at the paper detection sensor 22.

In this embodiment, another paper detection sensor 22 that detects passage of the paper P is arranged on a further downstream side of the most downstream line head 11Y, but installation thereof may be omitted.

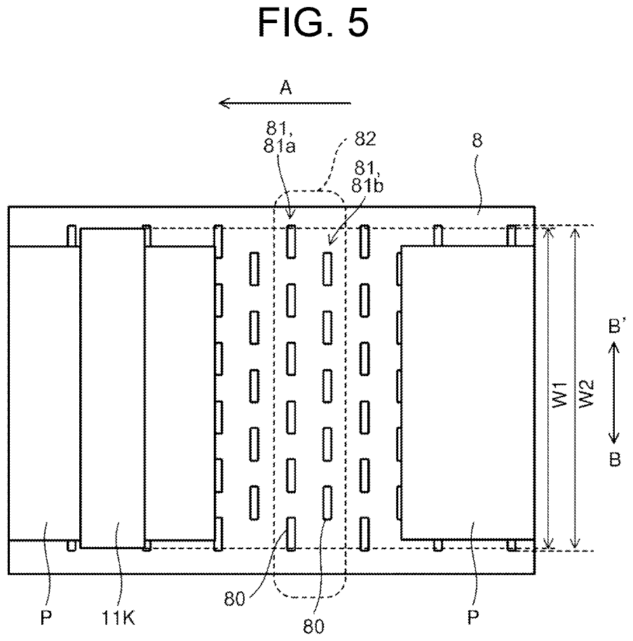

The CIS 23 for use in open part detection reads each open part 80 (see FIG. 5) of the first transport belt 8, which will be described later, to acquire open part reading data. The CIS 23 for use in open part detection is located at a position on an upstream side of the recording unit 9 and on a downstream side of the paper detection sensor 22 in the paper transport direction (the running direction of the first transport belt 8). The CIS 23 for use in open part detection may also serve as the paper detection sensor 22.

The CIS24 for use in paper size detection detects a size of the paper P that is fed to the first transport belt 8 from the paper feeding apparatus 3 (specifically, a length in the paper width direction) and a transport position of the paper P in the paper width direction. Thus, the control apparatus 110 (for example, the main control unit 110d) can control ejection of ink from each of the ink ejection ports 18 of the recording heads 17a to 17c in accordance with the size of the paper P used and the position of the paper P in the paper width direction to form an image on the paper P.

The meandering amount detection sensor 25 detects a meandering amount of the first transport belt 8. The meandering amount refers to an amount of displacement of the first transport belt 8 from its reference position in the belt width direction. The meandering amount detection sensor 25 is formed of a contact or non-contact displacement sensor that detects the meandering amount, for example, by detecting displacement of a side surface (one side surface) of the first transport belt 8. The meandering amount detection sensor 25 may be formed of a CIS that is long in the belt width direction. The meandering amount detection sensors 25 may be located at a plurality of positions in the running direction of the first transport belt 8. More specifically, the meandering amount detection sensor 25 includes a first meandering amount detection sensor 25a located in a position on a downstream side of the tension roller 7a in the running direction of the first transport belt 8 and a second meandering amount detection sensor 25b located in a position on a further downstream side of the first meandering amount detection sensor 25a and on an upstream side of the tension roller 7b.

The meandering correction mechanism 26 corrects meandering of the first transport belt 8 by tilting a rotation shaft of the roller (for example, the tension roller 7b) around which the first transport belt 8 is stretched. The main control unit 110d controls the meandering correction mechanism 26, based on the meandering amount of the first transport belt 8 detected by the meandering amount detection sensor 25. Thus, meandering of the first transport belt 8 is corrected.

The printer 100 further includes an operation panel 27, a storage unit 28, and a communication unit 29.

An operation panel 27 is an operation unit used for receiving various setting inputs. For example, a user can operate the operation panel 27 to input information on the size of the paper P to be set in the paper-feeding cassette 2, that is, the size of the paper P to be transported by the first transport belt 8. The user can also operate the operation panel 27 to input a number of papers P to be printed or instruct a start of a print job.

The storage unit 28 is memory that stores an operation program of the control apparatus 110 and stores various types of information, and is configured to include read only memory (ROM), random access memory (RAM), non-volatile memory, or the like. The information set by the operation panel 27 is stored in the storage unit 28.

The communication unit 29 is a communication interface used for transmitting and receiving information with an external apparatus (for example, a personal computer (PC)). For example, when the user operates the PC and sends a print command with image data to the printer 100, the image data and the print command are input to the printer 100 via the communication unit 29. In the printer 100, the main control unit 110d controls the recording heads 17a to 17c to eject ink, based on the image data, so that an image can be recorded on paper P.

The printer 100 of this embodiment also includes the control apparatus 110. The control apparatus 110 includes, for example, a central processing unit (CPU) and memory.

Specifically, the control apparatus 110 includes a data-generating unit 110a, a flushing control unit 110b, a data storage unit 110b, and the main control unit 110d.

The data-generating unit 110a generates flushing data that is driving data to cause ejection of ink from the recording heads 17a to 17c when flushing is executed. Herein, flushing refers to ejection of ink from the ink ejection ports 18 at a different timing from a timing that contributes to image formation (image recording) on the paper P for a purpose of reducing or preventing clogging of the ink ejection ports 18 due to drying of the ink.

The flushing control unit 110b drives the ink ejection ports 18 of the recording heads 17a to 17c, based on the flushing data generated by the data-generating unit 110a, to cause the recording heads 17a to 17c to execute flushing. The data storage unit 110c temporarily stores the open part reading data described above, original data used for flushing, which will be described later, the flushing data generated by the data-generating unit 110a, or the like. The data storage unit 110c is formed of, for example, RAM or nonvolatile memory. The main control unit 110d controls an operation of each part of the printer 100. The control apparatus 110 may further include an arithmetic unit that performs necessary calculations and a time counting unit that counts time. In addition, the data-generating unit 110a, the flushing control unit 110b, and the main control unit 110d may also serve as the arithmetic unit and the time counting unit that have been described above.

Furthermore, as illustrated in FIG. 3, the printer 100 includes ink receiving units 31Y, 31M, 31C, and 31K on an inner circumferential surface side of the first transport belt 8. When flushing is executed by the recording heads 17a to 17c, each of the ink receiving units 31Y to 31K receives and collects the ink that has been ejected from a corresponding one of the recording heads 17a to 17c and has passed through the open parts 80 of the first transport belt 8. Accordingly, the ink receiving units 31Y to 31K are provided at positions facing the recording heads 17a to 17c of the line heads 11Y to 11K, respectively, via the first transport belt 8. The ink collected in each of the ink receiving units 31Y to 31K is, for example, sent to a waste ink tank and is discarded, but may be reused without being discarded.

The second transport unit 12 described above is configured to include a second transport belt 12a and a drier 12b. The second transport belt 12a is stretched around two rollers, that is, a driving roller 12c and a driven roller 12d. The paper P that has been transported by the first transport unit 5 and on which the image is recorded by ejection of the ink by the recording unit 9 is transported by the second transport belt 12a, is dried by the drier 12b during transport, and is transported to the decurler unit 14.

### 2. Details of First Transport Belt

Next, details of the first transport belt 8 in the first transport unit 5 will be described. FIG. 5 is a plan view illustrating a configuration example of the first transport belt 8. The first transport belt 8 that sequentially transports the paper P includes the plurality of open parts 80. Each of the open parts 80 is formed of a hole that is long in the belt width direction (in an arrow BB′ direction). The shape of each of the open parts 80 in plan view is rectangular, as illustrated in FIG. 5, in this embodiment, but each of regions corresponding to corners of the rectangular shape of each of the open parts 80 may be rounded, and each of the open parts 80 in plan view may have some other shape (for example, an oval shape).

In this embodiment, a negative pressure suction method in which the paper P is attached to the first transport belt 8 by negative pressure suction is employed. Each of the open parts 80 also serves as a suction hole through which suction air generated by negative pressure suction passes.

In this embodiment, in the first transport belt 8, open part groups 82 each of which is formed of multiple ones of the open parts 80 are arranged to be aligned at regular intervals in the paper transport direction (the arrow A direction). Each of the open part groups 82 is formed of a plurality of open part arrays 81 and, in this embodiment, is formed of two open part arrays 81a and 81b.

Each of the open part arrays 81a and 81b includes multiple ones of the plurality of open parts 80 at equal intervals in the belt width direction (the arrow BB′ direction). Each of the open parts 80 of one open part array 81a is arranged so as to overlap with a corresponding one of the open parts 80 of the other open part array 81b as viewed from the transport direction of the paper P (the arrow A direction). In other words, in the first transport belt 8, the plurality of open parts 80 are arranged in a staggered pattern. Intervals between the open part groups 82 in the transport direction are equal to those between the open part arrays 81a and 81b in the transport direction.

The open parts 80 belonging to one open part array 81a and the open parts 80 belonging to the other open part array 81b are formed in a shape and at positions so as to be linearly symmetrical with respect to a center line extending in a center of the first transport belt 8 in the belt width direction in the transport direction. As a result, a number of the open parts 80 belonging to one open part array 81a is larger than a number of the open parts 80 belonging to the other open part array 80b only by one. The number of the open parts 80 of one open part array 81a may be the same as the number of the open parts 80 of the other open part array 80b.

Herein, when the head width of the line heads 11Y to 11K (the recording heads 17a to 17c) is W1 (mm), in the first transport belt 8, a maximum width W2 (mm) of one open part array 81a in the belt width direction is larger than W1. As a result, when the recording heads 17a to 17c execute flushing, the ink ejected from each of the ink ejection ports 18 of the recording heads 17a to 17c passes through either ones of the open parts 80 of the open part array 81a or the open parts 80 of the open part array 81b. Therefore, it is possible to cause the recording heads 17a to 17c to execute flushing over the entire head width to reduce clogging due to drying of the ink for all the ink ejection ports 18.

In addition, as illustrated in FIG. 5, in the first transport belt 8, all the ink ejection ports 18 of the recording heads 17a to 17c can be covered by the two different patterns by arranging two types of open part arrays, that is, the open part arrays 81a and 81b, having different array patterns for the open parts 80 in a repeated manner in the transport direction of the paper P. Furthermore, it is possible to perform line flushing between papers for a sum of lengths of the open parts 80 in the transport direction for the number of the open parts 80 in the transport direction by arranging the open parts 80 so that the patterns of two types alternately appear at arbitrary frequency between papers between which a distance is smallest.

### 3. Flushing Control

Next, flushing control of the recording heads 17a to 17c in this embodiment will be described. FIG. 6 schematically illustrates a method for generating flushing data used for inter-paper flushing. As used herein, the term “inter-paper flushing” refers to a flushing operation in which ink is ejected from the recording heads 17a to 17c to the open parts 80 positioned between the paper P and the paper P that are sequentially transported onto the first transport belt 8.

Flushing control of this embodiment can be applied to a case where flushing is performed on the open parts 80 located in a position shifted from the paper P in the transport direction and a timing of flushing is not limited to “between papers.” For example, it is possible to perform flushing by flushing control of this embodiment before forming an image on a first paper P or after forming an image on a last paper P.

### 3-1. Detection of Paper

First, when the paper P is transported from the pair of resist rollers 13 toward the first transport belt 8, the width (size) of the paper P is detected by the CIS 24 for use in paper size detection. Thereafter, when the paper detection sensor 22 detects passage of the paper P, a detection signal (vertical synchronous signal VSYNC) of the paper P is output from the paper detection sensor 22. The detection signal is a signal that goes high in a period in which the paper P is detected and goes low in a period in which the paper P is not detected.

### 3-2. Acquisition of Open Part Reading Data

Subsequently, when the paper P is fed onto the first transport belt 8, the CIS 23 for use in open part detection reads the open parts 80 of the first transport belt 8 to acquire open part reading data.

The CIS 23 for use in open part detection is, for example, of a transmissive type and is configured such that a light emitter and a light receiver are arranged on sides opposite to each other with the first transport belt 8 interposed therebetween. When the open parts 80 of the first transport belt 8 are positioned between the light emitter and the light receiver, light emitted from the light emitter passes through the open parts 80 and reaches the light receiver. On the other hand, when some other part of the first transport belt 8 than the open parts 80 (for example, a belt part of the first transport belt 8 or the paper P) is positioned between the light emitter and the light receiver, light emitted from the light emitter is reflected or absorbed by a belt surface or the paper P and does not reach the light receiver. Therefore, in the CIS 23 for use in open part detection, as illustrated in FIG. 6, 2-value data in which regions corresponding to the open parts 80 of the first transport belt 8 are indicated in white (not hatched) and other regions than the open parts 80 are indicated in black (hatched) is acquired as open part reading data. The acquired open part reading data is stored, for example, in the data storage unit 110c.

### 3-3. Flushing Data Generation

Next, the data-generating unit 110a generates flushing data used for causing ejection of ink to each of the open parts 80 located in a position shifted from the paper P in the transport direction on the first transport belt 8 from a corresponding one of the recording heads 17a to 17c. Further details are as follows.

### Recognition of Open Part Between Papers in Open Part Reading Data

First, the data-generating unit 110a reads the open part reading data from the data storage unit 110c. A start timing of reading of the open part reading data at this time is a timing delayed from a negate timing of the detection signal (VSYNC) of the paper detection sensor 22 by a time during which the paper P is transported for a distance between the paper detection sensor 22 and the CIS 23 for use in open part detection. Thus, the data-generating unit 110a can recognize an open part region 80R that is a region of an open part 80 located in a position shifted from the paper P detected by the paper detection sensor 22 in the transport direction among the plurality of open part regions 80 included in the open part region reading data. For example, in a case where the paper detection sensor 22 has sequentially detected a third paper P and a fourth paper from a top, the data-generating unit 110a can recognize the open part region 80R of the open part 80 positioned between the third paper P and the fourth paper P on the first transport belt 8 on the open part reading data by reading the open part reading data from the data storage unit 110c at the timing described above.

The start timing of reading described above is a timing when the paper detection sensor 22 and the CIS 23 for use in open part detection are in a positional relationship illustrated in FIG. 3, that is, when the paper detection sensor 22 is positioned in an upstream side of the CIS 23 for use in open part detection in the transport direction of the paper P. If the CIS 23 for use in open part detection is positioned in an upstream side of the paper detection sensor 22 in the transport direction of the paper P, the start timing of reading the open part reading data may be a timing traced back from the negate timing of the detection signal (VSYNC) of the paper detection sensor 22 only by a time during which the paper P is transported for a distance between the paper detection sensor 22 and the CIS 23 for use in open part detection.

### Reading of Original Data

The original data is stored and prepared in advance in the data storage unit 110c of the control apparatus 110. The original data is driving data of ejection ON that causes ejection of ink from all the ink ejection ports 18 of the recording heads 17a to 17c and has a data length of, for example, one lap of the first transport belt 8. The data-generating unit 110a reads the original data used for flushing described above from the data storage unit 110c.

### Generation of Flushing Data

The data-generating unit 110a generates flushing data in accordance with the open part region 80R of the recognized open part 80 (matching a position and a shape of the open part region 80R). More specifically, the data-generating unit 110a masks the original data for use in flushing read from the data storage unit 110c with the open part reading data also read from the data storage unit 110c. Thus, of the original data, only data that overlaps with the open part region 80R of the open part 80 remains. That is, of the original data, only data corresponding to the open part region 80R of each open part 80 located in a position shifted from the paper P in the transport direction on the first transport belt 8 remains. The data-generating unit 110a generates, as flushing data, the above-described data that corresponds to the open part region 80R of the open part 80 and remains. The flushing data generated by the data-generating unit 110a is stored, for example, in the data storage unit 110c.

### 3-4. Execution of Flushing

The flushing control unit 110b recognizes at least one non-image-forming period Tf, based on the detection signal output from the paper detection sensor 22. The non-image-forming period Tf is a period in which the open part 80 corresponding to the open part region 80R passes positions facing the recording heads 17a to 17c by running of the first transport belt 8. Since a distance between the paper detection sensor 22 and each of the recording heads 17a to 17c and transport speed of the paper P are known, a transport time required for transporting the paper P from the paper detection sensor 22 to each of the positions facing the recording heads 17a to 17c can be determined. Therefore, the flushing control unit 110b can recognize, as the non-image-forming period Tf, a period from a timing (time) obtained by adding the transport time described above to a timing (time) at which the detection signal output from the paper detection sensor 22 is switched from a high level to a low level to a timing (time) obtained by adding the transport time described above to a timing (time) at which the detection signal is switched from a low level to a high level.

Then, the flushing control unit 110b causes the recording heads 17a to 17c to execute flushing, based on the flushing data generated by the data generating unit 110a in the non-image-forming period described above. At this time, since the distance between the CIS 23 for use in open part detection and each of the recording heads 17a to 17c and the running speed of the first transport belt 8 are known, a moving time of the open part 80 of the first transport belt 8 from the CIS 23 for use in open part detection to each of the positions facing the recording heads 17a to 17c can be determined. Therefore, the flushing control unit 110b detects the open part 80 by the CIS 23 for use in open part detection, and then, after a specific time corresponding to the moving time has elapsed, the flushing control unit 110b causes the recording heads 17a to 17c to execute flushing, based on the flushing data. By this flushing, the ink ejected from each of the ink ejection ports 18 of the recording heads 17a to 17c passes through any one of the open parts 80 located in a position shifted from the paper P in the transport direction on the first transport belt 8. The ink that has passed through each of the open parts 80 is collected by the ink receiving units 31Y to 31K (see FIG. 3), and then, is sent to the waste ink tank.

The flushing data includes the driving data that causes ejection of ink to the open parts 80 of the open part array 81a and the driving data that causes ejection of ink to the open parts 80 of the open part array 81b. Which driving data is used to drive each of the ink ejection ports 18 may be determined based on the position of each of the ink ejection ports 18 in the belt width direction (which open parts 80 of the open part arrays 81a and 81b the position faces) in the belt width direction. In addition, the ink ejection ports 18 that can face both the open parts 80 of the open part array 81a and the open parts 80 of the open part array 81b may be driven by either one of the above-described two types of driving data.

A period from a timing (time) obtained by adding the transport time described above to a timing (time) at which the detection signal output from the paper detection sensor 22 is switched from a low level to a high level to a timing (time) obtained by adding the transport time to a timing (time) at which the detection signal is switched from a high level to a low level can be recognized as an image-forming period Tm in which the paper P that has been detected by the paper detection sensor 22 passes positions facing the recording heads 17a to 17c. Therefore, in the image-forming period Tm, an image can be formed on the paper P by driving the recording heads 17a to 17c, based on the image data.

### 4. Effects

As described above, in this embodiment, by using open part reading data acquired by directly reading each of the open parts 80 of the first transport belt 8 by the CIS 23 for use in open part detection, flushing data is generated on an immediate spot (immediate before flushing) in accordance with the open part region 80R of the open part 80 located in a position shifted from the paper P in the transport direction (in accordance with the position, size, and shape of the region 80) in the open part reading data. Thus, even in a case where the first transport belt 8 meanders or the position, size, and shape of the open parts 80 differ for each first transport belt 8 used, the recording head flushing control unit 110b can drive the recording heads 17a to 17c, based on the flushing data in the non-image-forming period Tf, so that ink ejected from each of the ink ejection ports 18 of the recording heads 17a to 17c can accurately pass through each of the open parts 80 of the first transport belt 8 (for example, each of the open parts 80 located in a position between papers). That is, flushing can be accurately performed without being affected by a running condition of the first transport belt 8, the position of each of the open parts 80 on the first transport belt 8, or the like when flushing is performed.

When the original data used for flushing is masked with the open part reading data, the data-generating unit 110a generates, as flushing data, data that corresponds to (overlaps with) the open part region 80R of each of the open parts 80 on the open part reading data and remains in the original data. Thus, flushing data used for causing ejection of the ink to each of the open parts 80 can be reliably acquired.

The original data used for flushing has a data length of one lap of the first transport belt 8. In this case, based on the open part reading data and the original data, the data-generating unit 110a generates flushing data that can cause the recording heads 17a to 17c to execute flushing in all non-image-forming periods Tf during one lap of the first transport belt 8.

### 5. Another Method for Generating Flushing Data

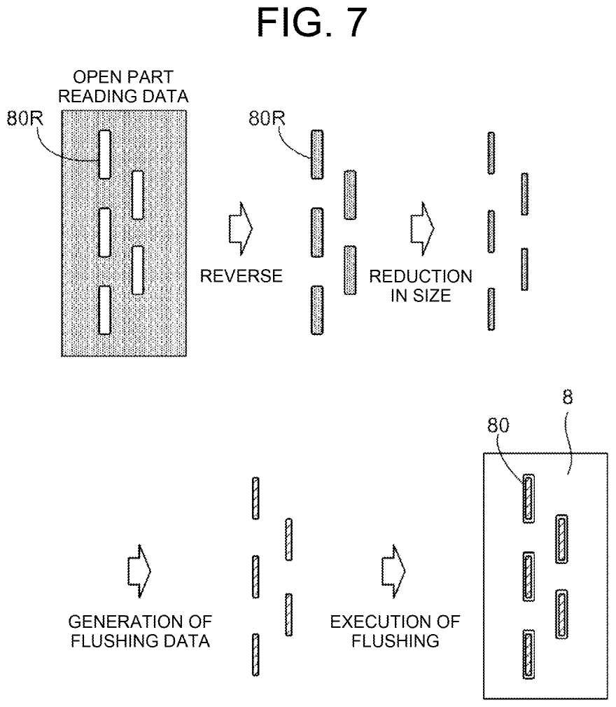

FIG. 7 is an explanatory diagram schematically illustrating another method for generating the flushing data. The data-generating unit 110a described above may be configured to reduce a size of the open part region 80R of each of the open parts 80 on the open part reading data and generate flushing data, based on data after the size of the open part region 80R has been reduced and the original data described above. For example, the data-generating unit 110a may be configured to generate flushing data by reversing the open part reading data, extracting only the open part region 80R from the open part reading data, reducing a size of the extracted open part region 80R, and multiplying the data after the size has been reduced by the original data.

When the flushing control unit 110b drives the recording heads 17a to 17c, based on the flushing data generated in a manner described above, the ink ejected from the recording heads 17a to 17c passes through a region narrower than the open part 80 in the first transport belt 8. Thus, even if the timing of ejection of ink slightly shifts from a specific timing or the transport speed of the first transport belt 8 slightly shifts from specific speed during flushing, a probability that the ejected ink passes through the open parts 80 without hitting a belt surface around the open parts 80 increases. Therefore, a situation where the ejected ink sticks to a portion around each of the open parts 80 of the first transport belt 8 and the first transport belt 8 is stained can be reduced.

At this time, in the first transport belt 8, the plurality of open parts 80 are preferably arranged in a pattern in which, when the flushing control unit 110b drives the recording heads 17a to 17c, based on the flushing data generated by the data-generating unit 110a, the ink ejected from each of all the ink ejection ports 18 of the recording heads 17a to 17c passes through any one of the open parts 80. The arrangement of the plurality of open parts 80 described above can be applied to a case where the size of the open part region 80R of the open parts 80 is reduced as described above to generate flushing data and, as a matter of course, can be also applied to a case where flushing data is generated without reducing the size of the open part region 80R as illustrated in FIG. 6.

With the plurality of open parts 80 arranged in the pattern described above on the first transport belt 8, both in a case where the data-generating unit 110a reduces the size of the open part region 80R of the open parts 80 to generate flushing data on the open part reading data and in a case where flushing data is generated without reducing the size, the ink ejected from each of all the ink ejection ports 18 of the recording heads 17a to 17c definitely passes through any one of the plurality of open parts 80, more specifically, the open parts 80 of either one of the open part array 81a or the open part array 81b during execution of flushing. Thus, flushing can be executed for all the ink ejection ports 18 of the recording heads 17a to 17c to reduce occurrence of clogging for all the ink ejection ports 18.

Specifically, in a case where the size of the open part regions 80R of open parts 80 is reduced to generate flushing data, a region in which the size of each of the open parts 80 of the open part array 81a has been reduced and a region in which the size of each of the open parts 80 of the open part array 81b has been reduced tend not to overlap with each other as viewed from the transport direction. If the respective reduced regions do not overlap the each other, as viewed from the transport direction, when the recording heads 17a to 17c are driven based on the generated flushing data, there are ink ejection ports 18 the ink from which cannot pass through the open parts 80 and flushing cannot be executed for all the ink ejection ports 18. Therefore, a configuration in which the plurality of open parts 80 are arranged in the pattern described above is very effective, specifically, in a case where the size of the open part regions 80R of the open parts 80 is reduced to generate flushing data.

### 6. Still Another Method for Generating Flushing Data

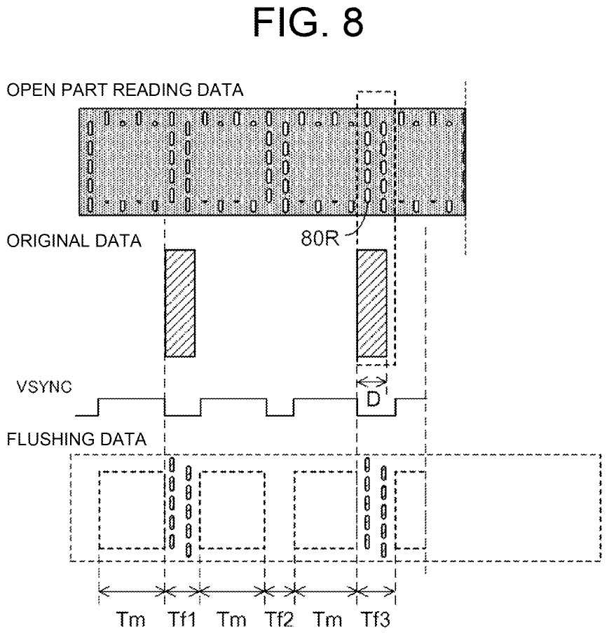

FIG. 8 is an explanatory diagram schematically illustrating still another method for generating the flushing data. The data-generating unit 110a may be configured to generate flushing data that causes the recording heads 17a to 17c to execute flushing intermittently in the plurality of non-image-forming periods Tf in accordance with ejection frequency of ink in the image-forming period Tm in which the paper P detected by the paper detection sensor 22 passes the positions facing the recording heads 17a to 17c.

FIG. 8 illustrates, as an example, a case where, when the non-image-forming period between the first and second papers P from the top is Tf1, the non-image-forming period between the second and third papers P is Tf2, and the non-image-forming period between the third and fourth papers P is Tf3, the data-generating unit 110a generates flushing data that executes flushing only in the non-image-forming periods Tf1 and Tf3. In the non-image-forming period Tf2, no flushing data is generated and no flushing is executed. As described above, performing flushing in the non-image-forming periods Tf1 and Tf3 with the non-image-forming period Tf2 in which no flushing is executed interposed therebetween is herein referred to as “intermittent.” That is, intermittent flushing refers to a mode in which flushing is executed in two non-image-forming periods with at least one non-image-forming period in which no flushing is executed interposed therebetween. All operations that are performed for a plurality of periods arranged in a chronological order with at least one period skipped are herein referred to as “intermittent” operations.

The flushing data described above can be generated by intermittently assigning the original data to the non-image-forming periods Tf1 and Tf3 and masking the original data with the open part reading data.

The ejection frequency of the ink in the image-forming period Tm can be recognized by the main control unit 110d that controls ejection of ink from each of the ink ejection ports 18 in the recording heads 17a to 17c in accordance with image data, for example, in the image-forming period Tm. That is, the main control unit 110d can determine, for example, by obtaining the number of times of ink ejections in a specific time at a specific ink ejection port 18, ejection frequency of ink ejected from the ink ejection port 18 (whether a number of times of ejections is larger than a specific number of times).

For example, when the ejection frequency of the ink in each image-forming period Tm is high, clogging of the ink ejection ports 18 due to drying of the ink can be reduced even without performing flushing in all non-image-forming periods Tf1 through Tf3 in some cases. As described above, the data-generating unit 110a generates flushing data that causes execution of flushing intermittently in the plurality of non-image-forming periods Tf1 to Tf3, that is, in the non-image-forming periods Tf1 and Tf3, and thus, unnecessary flushing can be suppressed by performing flushing intermittently, that is, in the non-image-forming periods Tf1 and Tf3, when the recording heads 17a to 17c execute flushing, based on the flushing data. As a result, an increase in wasted ink consumption due to unnecessary flushing can be suppressed.

The data-generating unit 110a generates flushing data, based on the open part reading data and the original data, and also generates flushing data by assigning the original data intermittently to the plurality of non-image-forming periods Tf1 to Tf3, that is, to the non-image-forming periods Tf1 and Tf3. Thus, flushing data that causes flushing to be performed intermittently, that is, in the non-image-forming periods Tf1 and Tf3, can be generated in a simple manner.

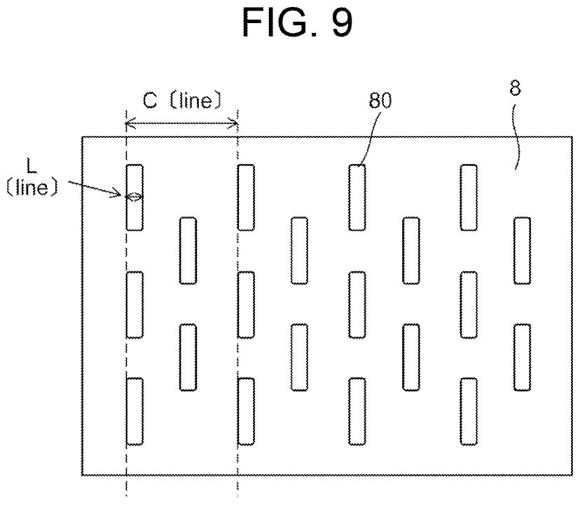

Incidentally, FIG. 9 schematically illustrates an arrangement pattern of the open parts 80 in the first transport belt 8. The data-generating unit 110a may be configured to set a length D of the flushing data described above in the transport direction of the paper P, based on a length L of each of the open parts 80 of the first transport belt 8 in the transport direction, an arrangement cycle C of the open parts 80 in the transport direction, and a number F of lines of the ink ejection ports 18 required for flushing in the non-image-forming period Tf. The lengths L and D and the arrangement cycle C are converted into the number of lines of ink ejection ports 18 (=a number of times of ejections in the transport direction).

In a case where L, C, D, and F are defined as described above, the following expression holds.

D≥(F/L)×C (where F/L is a value obtained by rounding up digits after the decimal point)

If the above-described expression is satisfied, flushing of more than a required number for lines can be performed on all the ink ejection ports 18 of the recording heads 17a to 17c. Therefore, by setting the length D of the flushing data in the transport direction of the paper P, for example, such that D=(F/L)×C is satisfied, necessary flushing can be performed on all the ink ejection ports 18 with a required minimum ink ejection amount in one non-image-forming period Tf. Thus, in this case, an increase in wasted ink consumption due to unnecessary flushing can be reliably suppressed. Even in a case where a distance between papers is larger than necessary, there is no need to perform flushing and, in a similar manner as described above, an increase in wasted ink consumption due to unnecessary flushing can be reliably suppressed. The data length D of the flashing data can be realized by setting a length of the original data in the transport direction as D.

### 7. Yet Another Method for Generating the Flushing Data

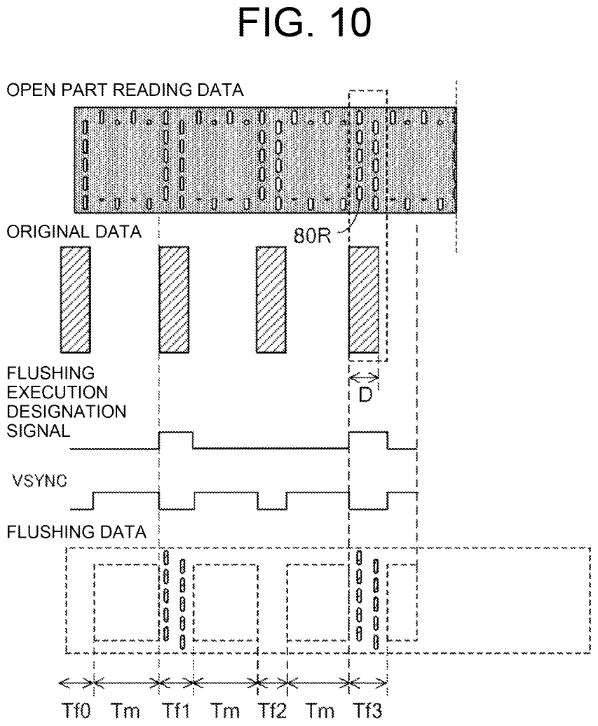

FIG. 10 is an explanatory diagram schematically illustrating yet another method for generating the flushing data. The main control unit 110d of the control apparatus 110 described above may be configured to output a flushing execution designation signal. The flushing execution designation signal is a signal that specifies execution and suspension of flushing in accordance with the ejection frequency of the ink in the image-forming period Tm. In this case, the data-generating unit 110a may be configured to generate flushing data, based on the open part reading data, the original data, and the flushing execution designation signal.

For example, when a period prior to the image-forming period Tm of the first paper P is set as the non-image-forming period Tf0, the data-generating unit 110a can generate the flushing data by assigning the original data described above to all the non-image-forming periods Tf0 to Tf3 and extracting data in a period in which the flushing execution designation signal is enabled (high level) from data that remains after the original data is masked by the open part reading data. The main control unit 110d can adjust a timing for enabling of the flushing execution designation signal and a length of an enabling period in accordance with the ejection frequency of the ink. In this case, the data-generating unit 110a can adjust a generation timing of the flushing data (whether flushing is performed) and the length of the flushing data in the transport direction, based on the flushing execution designation signal.

As illustrated in FIG. 10, in a case where the flushing execution designation signal is enabled in the non-image-forming periods Tf1 and Tf3, consequently, similar flushing data to that in FIG. 8 that causes flushing to be intermittently executed in the non-image-forming periods Tf1 and Tf3 can be acquired. Therefore, even in a case where flushing data is generated using the flushing execution designation signal, flushing can be performed intermittently in the non-image-forming periods Tf1 and Tf3, so that unnecessary flushing can be suppressed. As a result, an increase in wasted ink consumption due to unnecessary flushing can be suppressed.

### 8. Others

A case where the paper P is attracted to the first transport belt 8 by negative pressure suction and is thus transported has been described above, but the first transport belt 8 may be electrically charged such that the paper P is electrostatically attracted to the first transport belt 8 and is thus transported (an electrostatic suction method).

An example using a color printer that records color images using inks of four colors as an inkjet recording apparatus has been described above, but, even in a case where a monochrome printer that records monochrome images using a black ink is used, flushing data generation and flushing control according to this embodiment are applicable.

### Industrial Applicability

The present disclosure is applicable to inkjet recording apparatuses, such as inkjet printers or the like.

### Description of Reference Numerals

8 First transport belt

17a to 17c Recording head

18 Ink ejection port (nozzle)

22 Paper detection sensor (recording medium detection sensor)

23 CIS for use in open part detection (open part detection sensor)

80 Open part

100 Printer (inkjet recording apparatus)

110a Date-generating unit

110b Flushing control unit

110d Main control unit

P Paper (recording medium)

1. An inkjet recording apparatus comprising:
a recording head having a plurality of nozzles that eject ink;
a transport belt having a plurality of open parts and sequentially transporting a recording medium in a transport direction;
a flushing control unit that causes the recording head to execute flushing in which the ink is ejected from each of the nozzles of the recording head at a timing different from a timing that contributes to image forming to cause the ink to pass through one of the plurality of open parts;
a recording medium detection sensor that detects the reading medium to output a detection signal;
an open part detection sensor that reads the open parts of the transport belt to acquire open part reading data; and
a data-generating unit that recognizes, based on the detection signal, an open part region that is a region of an open part located in a position shifted from the recording medium detected by the recording medium detection sensor in the transport direction among regions of the plurality of open parts included in the open part reading data to generate flushing data in accordance with the open part region,
wherein the flushing control unit recognizes, based on the detection signal, at least one non-image-forming period in which the open part corresponding to the open part region passes a position facing the recording head by running of the transport belt, and causes the recording head to execute the flushing, based on the flushing data, in the at least one non-image-forming period.

2. The inkjet recording apparatus according to claim 1,
wherein, when original data used for flushing and prepared in advance is masked by the open part reading data, the data-generating unit generates, as the flushing data, data that corresponds to the open part region on the open part reading data and remains in the original data.

3. The inkjet recording apparatus according to claim 2,
wherein the data-generating unit reduces a size of the open part region on the open part reading data and generates the flushing data, based on data of the open part region after the size thereof has been reduced and the original data.

4. The inkjet recording apparatus according to claim 2,
wherein the original data has a data length of one lap of the first transport belt.

5. The inkjet recording apparatus according to claim 2,
wherein the data-generating unit generates the flushing data that causes the recording head to execute the flushing intermittently in a plurality of the non-image-forming periods in accordance with an ejection frequency of the ink in an image-forming period in which the recording medium detected by the recording medium detection sensor passes the position facing the recording head.

6. The inkjet recording apparatus according to claim 5,
wherein the data-generating unit generates the flushing data, based on the open part reading data and the original data, and generates the flushing data by intermittently assigning the original data to the plurality of non-image-forming periods.

7. The inkjet recording apparatus according to claim 5, further comprising:
a main control unit that outputs a flushing execution designation signal that specifies execution and suspension of the flushing in accordance with the ejection frequency of the ink in the image-forming period,
wherein the data-generating unit generates the flushing data, based on the open part reading data, the original data, and the flushing execution designation signal.

8. The inkjet recording apparatus according to claim 5,
wherein the data-generating unit sets a length of the flushing data in the transport direction, based on a length of the open parts in the transport direction in the transport belt, an arrangement cycle of the open parts in the transport direction, and a number of lines of the nozzles necessary for flushing in the non-image-forming period in the transport direction.

9. The inkjet recording apparatus according to claim 1,
wherein, in the transport belt, when the flushing control unit drives the recording head, based on the flushing data generated by the data-generating unit, the plurality of open parts are arranged in a pattern in which inks ejected from all the nozzles of the recording head pass any one of the open parts.
